(19) United States
(12) Patent Application Publication
(10) Pub. No.: US 2017/0242434 A1
(43) Pub. Date: Aug. 24, 2017

(54) METHOD AND DEVICE FOR OPERATING AN AUTOMATED MOTOR VEHICLE

(71) Applicant: Robert Bosch GmbH, Stuttgart (DE)

(72) Inventor: Marlon Ramon Ewert, Untergruppenbach (DE)

(21) Appl. No.: 15/435,410

(22) Filed: Feb. 17, 2017

(30) Foreign Application Priority Data
Feb. 19, 2016 (DE) 102016202590.2

(51) Int. Cl. G05D 1/00; G09B 19/16; G05D 1/02

(52) U.S. Cl. CPC G05D 1/0061; G05D 1/0088; G05D 1/0212; G09B 19/167

(57) ABSTRACT

A method for operating an automated motor vehicle, having the steps: ascertaining of automated driving parameters during a manual controlling of the automated motor vehicle; and defined intervention by the automated motor vehicle in the manual controlling of the automated motor vehicle according to the ascertained automated driving parameters, the defined intervention being carried out corresponding to a degree of agreement of the automated driving parameters with the manual driving parameters inputted during the manual controlling of the automated motor vehicle.

### FIELD OF THE INVENTION

The present invention relates to a method for operating an automated motor vehicle. The present invention further relates to a device for operating an automated motor vehicle.

### BACKGROUND INFORMATION

An automated, or autonomous, vehicle is a vehicle that operates without a driver. The vehicle drives autonomously in that for example it recognizes a course of a roadway, other traffic participants, or obstacles automatically, and calculates corresponding control commands in the vehicle, and forwards these to actuators in the vehicle, whereby the driving course of the vehicle is correctly influenced. In a fully autonomous vehicle, the driver is not involved in the activity of driving.

Currently available vehicles are not yet capable of acting autonomously. On the one hand, this is because the corresponding technology is not yet fully mature. On the other hand, this is because currently it is still legally required that the driver of the vehicle has to be capable of intervening in the driving events at all times. This makes the realization of autonomous vehicles more difficult. It is foreseeable that some years from now fully autonomous vehicle systems will come onto the market, as soon as the named hurdles have been overcome.

Driver assistance systems are known that realize electronic auxiliary devices in motor vehicles for supporting the driver in particular driving situations. Here, safety aspects, but also increasing driver convenience, are often in the foreground. A further aspect is the improvement of driving economy. Driver assistance systems engage partly autonomously or autonomously in the drive mechanism, control mechanism (e.g. gas, brakes, etc.), or signaling devices of the vehicle, or, through suitable human-machine interfaces, warn the driver shortly before or during critical situations. Currently, most driver assistance systems are designed such that the responsibility remains with the driver, and the driver is thus not disabled.

For driver assistance systems, various types of environmental sensor systems are used, including for example:
ultrasound (e.g. for parking assistance)
radar (e.g. for lane change assistance, automatic distance warning)
lidar (e.g. for blind spot monitoring, automatic distance warning, distance regulation, pre-crash and pre-brake)
camera (e.g. for lane departure warning, traffic sign recognition, lane change assistant, blind spot monitoring, emergency braking system for protecting pedestrians).

Car-to-car communication (Car2Car or C2C) is understood as the exchange of information and data between motor vehicles. The goal of this exchange of data is to give the driver early warning of critical and dangerous situations. The vehicles involved collect data, such as ABS interventions, steering angle, position, direction, and speed, and send this data wirelessly (for example via WLAN, UMTS, etc.) to other traffic participants. Here, the “range of view” of the driver is to be extended by electronic means. Car-to-infrastructure (C2I) refers to the exchange of data between a vehicle and the surrounding infrastructure (e.g. traffic light installations).

The named technologies are based on the interaction of sensors of the various traffic partners, and use the newest methods of communication technology to exchange this information. For this purpose, it is provided that autonomous, or partly autonomous, vehicles will in the future exchange data using car-to-car communication systems.

### SUMMARY

An object of the present invention is to provide an improved method for operating an automated motor vehicle.

According to a first aspect, this object is achieved by a method for operating an automated motor vehicle, having the steps:
ascertaining automated driving parameters during manual control of the automated motor vehicle; and
defined intervention of the automated motor vehicle in the manual controlling of the automated motor vehicle, according to the ascertained automated driving parameters, the defined intervention being carried out corresponding to a degree of agreement of the automated driving parameters with the manual driving parameters inputted during the manual controlling of the automated motor vehicle.

According to a second aspect, the object is achieved by a device for operating an automated motor vehicle, the automated motor vehicle being capable of being manually operated, having:
an intervention device that is fashioned to carry out a defined intervention in a manual driving operation of the automated motor vehicle as a function of a degree of agreement of the automated driving parameters with the manual driving parameters inputted during the manual controlling of the automated motor vehicle.
In this way, a kind of “driving school” mode is realized for the automated motor vehicle that can be used for the training of driving students, and that can effectively contribute to avoiding accidents. Advantageously, for carrying out the method it is not necessarily required that a human driving instructor be present in the motor vehicle.

Advantageous developments of the method and of the device are the subject matter of the dependent claims.

An advantageous development of the method provides that an ascertaining of an automated target trajectory with the associated automated control interventions is carried out during the manual controlling of the automated motor vehicle, a defined intervention of the automated motor vehicle in the manual controlling of the automated motor vehicle being carried out according to the ascertained automated target trajectory and the associated automated control interventions. In this way, specific automatically ascertained driving parameters can be compared with driving parameters of the actual driving operation, an intervention of the automated motor vehicle in the manually controlled driving operation being carried out corresponding to a deviation between the named parameters.

An advantageous development of the method provides that the method is activated from within the motor vehicle or from outside the automated motor vehicle. In this way, different activation modes are advantageously enabled.

A further advantageous development of the method provides that the method can be configured via a human-machine interface of the automated motor vehicle. In this way, a comfortable configuration possibility for the method is supported.

A further advantageous development of the method is distinguished in that a degree of learning progress of a driver of the automated motor vehicle is indicated on the human-machine interface. In this way, the driving student can obtain efficient feedback about his/her learning progress.

A further advantageous development of the method provides that an intervention of the automated motor vehicle in the manual controlling of the automated motor vehicle is ascertained on the basis of a driving history. In this way, a further possibility is provided for ascertaining a degree of intervention, so that a better versatility of the driving school mode is supported.

A further advantageous development of the method provides that the intervention of the automated motor vehicle is adapted in automated fashion. In this way, a still higher degree of efficiency of the driving school mode of the automated motor vehicle is supported.

A further advantageous development of the method provides that the intervention of the automated motor vehicle is carried out as a function of a state of training of the driver of the automated motor vehicle. In this way, the autonomous vehicle is adapted to the learning progress of the driving student, so that an efficient acquisition of practical driving skill is supported.

A further advantageous development of the method provides that the state of training of the driver is acquired by the automated motor vehicle, and a degree of intervention of the automated motor vehicle in the manual driving operation of the automated motor vehicle is set as a function of the acquired state of training. In this way, a maximally efficient acquisition of practical driving skill is supported.

A further advantageous development of the method provides that the degree of intervention is set automatically or manually. In this way, a flexible adaptation of the method to the driving ability of the driving student is supported.

A further advantageous development of the method provides that a communication with the human-machine interface is carried out at least partly in voice-controlled fashion. In this way, an efficient communication between the driving student and the automated motor vehicle is supported.

In the following, the present invention is described in detail with further features and advantages, on the basis of a plurality of Figures. All described or represented features, in themselves or in any combination, form the subject matter of the present invention, independent of their summarization in the patent claims or their relations of dependence, and independent of their formulation or representation in the description or in the Figures. The figures are above all intended to illustrate the principles essential to the present invention.

Disclosed features of the method result analogously from corresponding disclosed features of the device, and vice versa. This means in particular that features, technical advantages, and embodiments relating to the method result in an analogous fashion from corresponding embodiments, features, and advantages of the device.

### BRIEF DESCRIPTION OF THE DRAWINGS

FIG. 1 shows a schematic representation of a human-machine interface of a proposed device for operating an automated motor vehicle.

FIG. 2 shows a schematic diagram of a specific embodiment of a device for operating an automated motor vehicle.

FIG. 3 shows a schematic sequence of a specific embodiment of the method according to the present invention.

### DETAILED DESCRIPTION

In the following, the term “automated motor vehicle” is used synonymously with the meanings “partly automated motor vehicle,” “autonomous motor vehicle,” and “partly autonomous motor vehicle.”

A core idea of the present invention is to provide a method and a device for realizing a driving school mode in an automated motor vehicle. Advantageously, in this way it is possible to use the proposed method and the proposed device for the purpose of driving instruction in an automated motor vehicle.

Here, it is essential that a driving student manually control the automated motor vehicle during his/her driving training. However, in the background, within the autonomous or partly autonomous vehicle, a calculation continues to be carried out of automated driving parameters, in particular of a vehicle trajectory with the associated steering, braking, and acceleration interventions, as if the motor vehicle were being driven in automated (i.e., autonomous or partly autonomous) fashion.

At first, the manual controlling of the vehicle is carried out solely by the driving student, as long as no critical situation arises. However, if a critical situation arises during the manual vehicle controlling by the student, then within the scope of the present invention control of the automated motor vehicle is taken away from the student, so that the automated motor vehicle is subsequently operated in automated (i.e. partly autonomous or autonomous) fashion until the critical situation has been overcome. Here, no intervention on the part of the driving instructor is required, because the automated motor vehicle intervenes automatically in the driving activity. In this way, a degree of safety of the driving instruction can be significantly increased. Critical situations can include for example an immediately impending vehicle crash and/or collision with a pedestrian and/or vehicle rollover and/or skidding of the motor vehicle. Critical situations can also be caused by driver error or by inattentiveness on the part of the driving student.

The removal of the driving student's control over the automated motor vehicle during driving instruction can be done by the automated motor vehicle, because the planned trajectory of the motor vehicle for autonomous vehicle operation continues to be calculated in the background even though the motor vehicle is being controlled by the driver in manual operation. The removal of the student's manual control can take place at any time during driving. If the student's control over the motor vehicle is taken away, then any interventions that the driving student makes in driving activity have no effect, and these interventions go, so to speak, “into the void.”

A critical situation can be recognized within the motor vehicle during driving school operation by driver assistance systems such as ESP, or electronic stability control. In addition, a recognition of a critical situation in the automated motor vehicle takes place during manual driving school operation through a comparison of the momentary vehicle trajectory, the momentary steering angle, and the momentary acceleration/deceleration with the vehicle trajectory calculated by the motor vehicle, the steering angle, and the momentary acceleration/deceleration that would be necessary to autonomously operate the motor vehicle safely. If a critical situation is recognized, then the driving student's control over the vehicle can be immediately taken away. This lasts until the motor vehicle is in a safe state.

When a safe state of the automated motor vehicle has been reestablished, then control over the automated motor vehicle can be given back to the driving student. For this purpose the vehicle signals to the student, for example audiovisually, that the student can again take control over the automated motor vehicle. As soon as the driving student has taken control over the automated motor vehicle, the automated motor vehicle is again controlled in manual operation. The calculation of the theoretical vehicle trajectory and the associated steering, braking, acceleration interventions then again takes place in the background as if the automated motor vehicle were traveling autonomously, with the goal of recognizing a critical situation. If another critical situation arises, then control over the automated motor vehicle is again temporarily taken away from the driving student until the automated motor vehicle is in a safe state.

In the described manner, a reliable training of driving students in autonomous or partly autonomous motor vehicles is possible without a driving instructor manually intervening in the driving activity via additional devices in the motor vehicle. The intervention in the driving activity takes place through the automated motor vehicle itself. The precondition for the realization of the proposed method and the proposed device is the presence of manual control means for the automated motor vehicle, such as steering means (steering wheel), means for setting a speed (gas pedal), means for braking the motor vehicle (brake pedal), which make it possible for the driver to manually intervene in the driving activity and that are used for the purpose of driving instruction.

Here, the driving instructor can be in the motor vehicle, instructing the driving student as to how to drive. Alternatively, it is also conceivable that during instruction the driving instructor is not situated inside the automated motor vehicle, but rather at an external location.

In the latter case, communication between the instructor and the student can take place via an audiovisual wireless connection, such as a car-to-infrastructure communication interface in the automated motor vehicle. A controlling of the vehicle by the driving instructor can also take place in such a case via the car-to-infrastructure communication interface. Here, the driving instructor can for example communicate to the student a route that the student has to drive. This is then for example fed into the navigation system of the automated motor vehicle.

Optionally, speech and/or video communication, using car-to-infrastructure communication, is also possible between the instructor and student, for example via a navigation system already present in the automated motor vehicle.

The driving instructor may also be given the possibility of setting different driving instruction modes in the automated motor vehicle. This setting can take place via a human-machine interface (HMI) if the driving instructor is situated in the automated motor vehicle, or via the car-to-infrastructure communication interface if the driving instructor is at a different location outside the automated motor vehicle during driving instruction.

The named driving instruction modes in the automated motor vehicle can be fashioned in various degrees to which the automated motor vehicle intervenes in driving activity during driving operation. For example, if a driving student is at the beginning of training, then the degree of intervention of the automated motor vehicle in driving activity in a critical situation can for example be set to full intervention (i.e. 100%). This means that in a critical situation the automated motor vehicle will immediately take complete control over the automated motor vehicle. As the driving student's degree of training progresses, the degree of intervention of the automated motor vehicle can be reduced by selection of at least one further mode by the driving instructor, for example approximately 50% (partial intervention).

This means that in this case in very critical situations the automated motor vehicle intervenes in the driving activity only if for example the automatic motor vehicle comes impermissibly close to another vehicle or traffic participant. At the end of the driving education, or in order to carry out a driving test, in an additional mode the degree of intervention can be set to 0%. This means that the driving student himself/herself has control of the automated motor vehicle, and even in a critical situation the automated vehicle does not intervene in the driving activity. This is necessary in order to test the ability of the driving student in critical situations.

In addition or alternatively, the necessary degree of intervention of the automated motor vehicle in the driving activity can be calculated within the vehicle on the basis of the driving history of the student, and, in a further step, can be adapted in automated fashion without the driving instructor.

In addition, within the automated motor vehicle a comparison can take place between the target trajectory of the automated motor vehicle and the actual trajectory being driven by the driving student. This comparison provides information about the learning progress of the student. Here, the target trajectories and the actual trajectories for one or more driving hours can be stored and compared to one another, and for example can be displayed on the human-machine interface in the automated motor vehicle for the driving instructor and the student together with a degree of learning progress calculated by the vehicle. Also conceivable is the communication by the automated motor vehicle of these target trajectories and actual trajectories, together with the learning progress, to the driving instructor via the car-to-infrastructure communication interface, if the driving instructor is at a different location, or for documentation purposes for the driving school.

In addition, an automated registration of the driving student for a driving test can be carried out by the automated motor vehicle if for example the comparison of target and actual trajectories is below a defined value in a defined manner for a specific period of time, or if a particular number of driving hours have been carried out without interventions by the automated motor vehicle in critical situations.

It is also conceivable that, using the proposed method, a driving test no longer takes place. Instead, the student is automatically granted a driver's license as soon as, for example, the comparison of target and actual trajectories falls below a specified value by a certain percent, or as soon as a specified number of driving hours have been carried out without intervention by the automated motor vehicle in the driving activity, or as soon as the learning progress of the student is above a defined value. The issuing of the drivers license can in this case take place via a car-to-infrastructure communication connection between the automated motor vehicle and the testing authority.

It is also conceivable for an exchange of data to take place between the automated motor vehicle and the surrounding vehicles within a defined minimum distance, such that this data exchange can take place via a car-to-car communication interface. Inter alia, here the following data can be communicated to surrounding vehicles:
set mode of intervention of the automated motor vehicle in the driving activity (e.g. 100%)
learning progress of the driving student
target trajectory and actual trajectory of the automated motor vehicle (position data) over time

If a vehicle in the surrounding vicinity is a non-automated vehicle, or an automated vehicle in manual operation, this information is displayed to the vehicle driver via the human-machine interface, so that this driver can adapt his/her driving behavior, for example by driving at a greater distance from the driving school vehicle. If, in contrast, a vehicle in the surrounding vicinity is an automated vehicle not traveling in manual operation, then a display of the data on a human-machine interface is not necessarily required in this vehicle. Instead, the nearby automated vehicle will automatically adapt its driving behavior to the driving behavior of the driving school vehicle, for example by throttling its speed or maintaining a greater distance from the driving school vehicle, in accordance with the learning progress of the driving student.

Within the scope of the present invention, as soon as a critical situation arises the driving school vehicle automatically intervenes in the driving activity, with the aid of the vehicle trajectory calculated in the background and the associated steering, braking, and acceleration interventions, depending on the set mode. A critical situation can include an immediately impending vehicle crash and/or a collision with a pedestrian and/or a rollover and/or skidding of the vehicle. In addition, a critical situation can be caused by driver error or inattentiveness on the part of the driving student.

Further advantages of the present invention include the following:
Installation of additional devices, such as mirrors or additional brake, accelerator, and clutch pedals for the driving instructor in driving school vehicles can be omitted.
Intervention in the driving activity is done by the automated vehicle itself and not, as is conventionally the case, by the driving instructor.
The driving student is led step-by-step to independent driving via various intervention modes, minimizing the risk of accidents.
Learning progress can be checked at any time by the driving instructor and student.
The driving instructor does not necessarily have to be in the driving school vehicle for driving instruction.
At a particular stage of the proposed method, the driving instructor can be completely done without.
Driving tests can be automated and are therefore comparable.
An automated issuing of the driver's license can take place.
Surrounding vehicles can timely adapt their driving behavior to the driving behavior of the driving student.

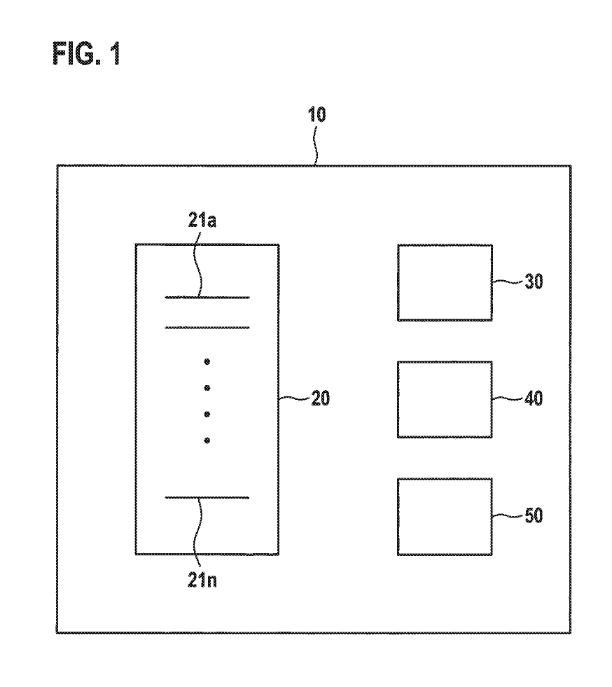

In the following, on the basis of FIG. 1 an example of a human-machine interface is described that is used to make it possible for the driver to control the automated motor vehicle using the proposed method. The human-machine interface is preferably a touchscreen, but other systems are also conceivable, such as for example exclusively or partly voice-controlled human-machine interfaces.

Visible is a graphic human-machine interface 10 of the automated motor vehicle. Using a selection element 20, it is possible for a user of the automated motor vehicle to set driving instruction modes 21a . . . 21n that represent a degree of intervention of the automated motor vehicle in the manually controlled driving activity.

A degree of learning progress of the driving student can be graphically outputted by a further display element 30; the output can optionally be supplemented by an acoustic output or replaced by an acoustic output.

A degree of intervention of the automated motor vehicle in the manually controlled driving activity can be indicated by a further display element 40.

A further display element 50 can for example be provided in order to indicate to the driving student a driving route specified by an external driving instructor.

Of course, the depicted human-machine interface 10 is shown only qualitatively, and can be supplemented with many further display or input elements that are not shown.

As a result, using the proposed method the level of safety in street traffic can be advantageously increased, and a homogenous flow of traffic can be provided.

Advantageously, the method according to the present invention can be implemented as software, running for example on human-machine interface 10 and/or device 100 and/or on an external computing device. In this way, easy adaptability of the method is supported.

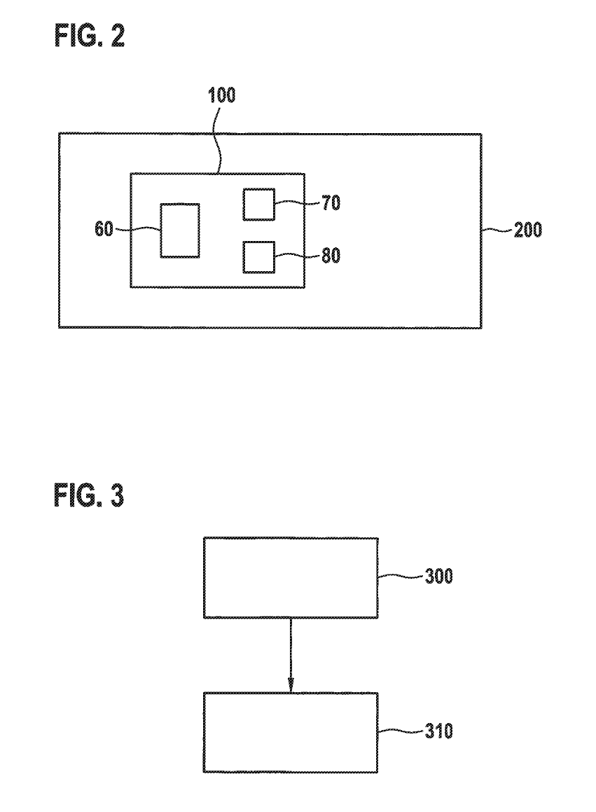

FIG. 2 shows a block diagram of a specific embodiment of a device 100 for operating an automated motor vehicle 200. Device 100 includes an intervention device 60 by which an intervention in manual driving operation of automated motor vehicle 200 can be carried out as a function of a defined critical driving situation of automated motor vehicle 200. Visible are a car-to-car communication interface 70 and a car-to-infrastructure communication interface 80 for the purposes described above.

FIG. 3 shows a schematic sequence of a specific embodiment of the method according to the present invention.

In a step 300, an ascertaining is carried out of automated driving parameters during a manual controlling of automated motor vehicle 200.

In a step 310, automated motor vehicle 200 carries out a defined intervention in the manual controlling of automated motor vehicle 200 in accordance with the ascertained automated driving parameters, the defined intervention being carried out corresponding to a degree of agreement of the automated driving parameters with the manual driving parameters inputted during the manual controlling of automated motor vehicle 200.

Summarizing, the present invention proposes a method for operating an automated motor vehicle, the automated motor vehicle having manual intervention means and being used to impart practical driving skill to a driving student. As a function of degrees of learning progress of the driving student, a degree of intervention by the automated motor vehicle can be reduced over time. As a result, a convenient possibility is realized for giving a driving student a degree of practical driving skill that is suitable for everyday driving.

A person skilled in the art will modify the features of the present invention, and/or combine them with one another, in a suitable manner without departing from the core of the present invention.

What is claimed is:

1. A method for operating an automated motor vehicle, comprising:
ascertaining an automated driving parameter during a manual controlling of the automated motor vehicle; and
performing a defined intervention by the automated motor vehicle in the manual controlling of the automated motor vehicle according to the ascertained automated driving parameter, the defined intervention being performed according to a degree of agreement of the automated driving parameter with a manual driving parameter inputted during the manual controlling of the automated motor vehicle.

2. The method as recited in claim 1, further comprising:
ascertaining an automated target trajectory with an associated automated control intervention during the manual controlling of the automated motor vehicle; and
performing a defined intervention in the manual controlling of the automated motor vehicle by the automated motor vehicle according to the ascertained automated target trajectory and the associated automated control intervention.

3. The method as recited in claim 1, wherein the method is activated one of from within and from outside the automated motor vehicle.

4. The method as recited in claim 3, wherein the method is configurable via a human-machine interface of the automated motor vehicle.

5. The method as recited in claim 4, further comprising displaying on the human-machine interface a degree of learning progress of a driver of the automated motor vehicle.

6. The method as recited in claim 1, wherein the intervention by the automated motor vehicle in the manual controlling of the automated motor vehicle is ascertained on the basis of a driving history.

7. The method as recited in claim 6, wherein the intervention by the automated motor vehicle is adapted in automated fashion.

8. The method as recited in claim 1, wherein the intervention by the automated motor vehicle is carried out as a function of a state of training of a driver of the automated motor vehicle.

9. The method as recited in claim 8, wherein:
the state of training of the driver of the automated motor vehicle is acquired, and
a degree of intervention by the automated motor vehicle in the manual driving operation of the automated motor vehicle is set as a function of the acquired state of training.

10. The method as recited in claim 9, wherein the degree of intervention is set one of automatically and manually.

11. The method as recited in claim 4, wherein a communication with the human-machine interface is carried out at least partly in voice-controlled fashion.

12. A device for operating an automated motor vehicle, the automated motor vehicle being capable of being operated manually, the device comprising:
an intervention device for carrying out a defined intervention in a manual driving operation of the automated motor vehicle as a function of a degree of agreement of an automated driving parameter with a manual driving parameter inputted during a manual controlling of the automated motor vehicle.

13. The device as recited in claim 12, wherein the device includes at least one of:
at least one car-to-car device, and
at least one car-to-infrastructure device.

14. A computer program product having a program code stored on a computer-readable data carrier and for carrying out on an electronic intervention device a method for operating an automated motor vehicle, the method comprising:
ascertaining an automated driving parameter during a manual controlling of the automated motor vehicle; and
performing a defined intervention by the automated motor vehicle in the manual controlling of the automated motor vehicle according to the ascertained automated driving parameter, the defined intervention being performed according to a degree of agreement of the automated driving parameter with a manual driving parameter inputted during the manual controlling of the automated motor vehicle.
